(19) United States
(12) Patent Application Publication
(10) Pub. No.: US 2025/0139583 A1
(43) Pub. Date: May 1, 2025

(54) System and Method For Agent to End User Communication Supervision Mechanism

(71) Applicant: Text S.A., Wroclaw (PL)

(72) Inventor: Marcin Dojwa, Wroclaw (PL)

(73) Assignee: Text S.A., Wroclaw (PL)

(21) Appl. No.: 18/384,894

(22) Filed: Oct. 30, 2023

(51) Int. Cl. G06Q 10/105; H04L 51/04

(52) U.S. Cl. CPC G06Q 10/105; H04L 51/04

(57) ABSTRACT

The disclosed invention pertains to a comprehensive agent-to-end-user supervisory system and method with advanced technical features. The system encompasses modules for real-time chat session oversight, agent authorization, consolidated chat view, whisper communication, and cloud-based data management. It further offers structured data insertion for language model training, comprehensive tagging, and feedback capabilities. The method involves real-time oversight, agent authorization, communication facilitation, and optimization through data analysis. This innovation enhances chat session management, empowering agents while ensuring data security and efficiency for optimal user experiences.

### BACKGROUND OF THE INVENTION

The disclosed innovation pertains to the realm of instant communication and, more specifically, to the interaction between a designated agent, representing a company, and an end user, referring to an individual utilizing instant communication channels to access support, assistance, or sales offers.

Within the dynamic landscape of online communication, the ascension of chat-based interactions has emerged as a dominant and efficient mode of engagement. Amid this paradigm shift, the harmonization of exchanges between customers and agents has risen to a position of paramount significance. A central challenge involves the effective oversight and orchestration of chat sessions, a task integral to ensuring fluid support provision and the swift resolution of issues. The invention under discussion responds to this imperative by introducing an innovative method and system tailored to amplify the quality of interactions between customers and company representatives within the digital domain.

Traditionally, the supervision of chat sessions has entailed manual observation and sporadic intervention. However, this traditional approach can prove inadequate when confronted with substantial chat volumes or situations requiring immediate intervention. In this context, the disclosed invention presents a holistic resolution by proposing an automated and seamlessly integrated approach that facilitates the monitoring and guidance of ongoing chat exchanges.

Central to this innovation is the acknowledgment of the growing importance of chat communication, driven by its efficiency and immediacy. This recognition underscores the potential for the supervision mechanism to profoundly enhance the interactions between human agents and their digital counterparts, whether they are automated or AI-driven. By embracing this evolution and introducing a sophisticated supervisory framework, the invention aspires to propel the collaborative synergy between humans and AI agents, thereby elevating the efficacy and responsiveness of customer engagement. Through this transformative step, the invention aligns with the trajectory of chat communication's growth and underscores its potential to reshape how companies and customers interact in the digital age.

### BRIEF SUMMARY OF THE INVENTION

At the core of this invention resides a supervisory mechanism seamlessly integrated into the digital platform, a strategic implementation designed to enhance operational efficiency and mitigate the prospective expenditures associated with conventional manual oversight. This methodological apparatus empowers duly authorized agents to conduct real-time supervision over ongoing chat sessions, thereby facilitating expeditious aid and the proficient resolution of matters at hand. Functioning within a designated sector of the platform, this mechanism affords agents a centralized and comprehensive perspective over the continuum of active chat interactions.

To initiate the supervision process, an agent selects a chat session from a list and activates the “Supervise chat” function. This establishes a connection between the supervising agent and the ongoing chat, enabling real-time observation and intervention when needed. The invention further empowers supervising agents to provide discreet guidance using “whispers” messages visible exclusively to the supervising agent, maintaining customer privacy.

This invention promotes collaboration among agents involved in chat sessions. Agents within supervised chats can exchange private messages with supervising agents, fostering efficient problem-solving and knowledge sharing within the team.

In situations where swift intervention is required, the invention allows agents to seamlessly transition into ongoing chats. This is particularly valuable when automated responses fall short or when an agent's response time is prolonged. This transition capability empowers agents to step in and address issues effectively, contributing to improved customer experiences.

Additionally, concluding supervisory roles is effortless within this invention. Agents can smoothly exit supervisory positions, either from the chat list or the chat interface, ensuring a flexible workflow that adapts to changing needs.

In summary, this invention introduces a transformative approach to overseeing and enhancing chat interactions within digital communication. By enabling authorized agents to actively supervise, guide, and seamlessly transition into chat sessions, this invention revolutionizes the way customer-agent interactions are managed. This advancement streamlines communication, ensures timely assistance, and contributes to elevated customer satisfaction and engagement.

### BRIEF DESCRIPTION OF THE SEVERAL VIEWS OF THE DRAWINGS

Further advantages, features and details of the various embodiments of this disclosure will become apparent from the ensuing description of a preferred exemplary embodiment or embodiments and further with the aid of the drawings. The features and combinations of features recited below in the description, as well as the features and feature combination shown after that in the drawing description or in the drawings alone, may be used not only in the particular combination recited but also in other combinations on their own without departing from the scope of the disclosure.

In the following, advantageous examples of the disclosure are set out with reference to the accompanying drawings, wherein:

FIG. 1 depicts a flowchart with the communication between the control module, authorization module and database with the whisperer functionality and data input included.

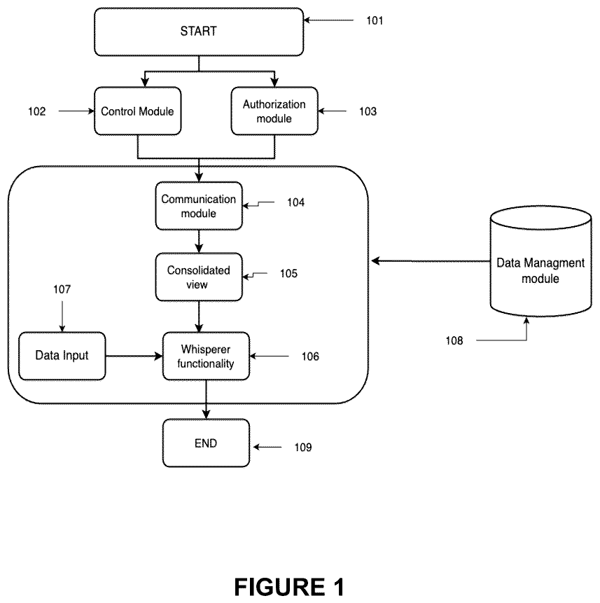

FIG. 2 depicts a flowchart with the communication between the control module wherein the validation of user being active or not is included.

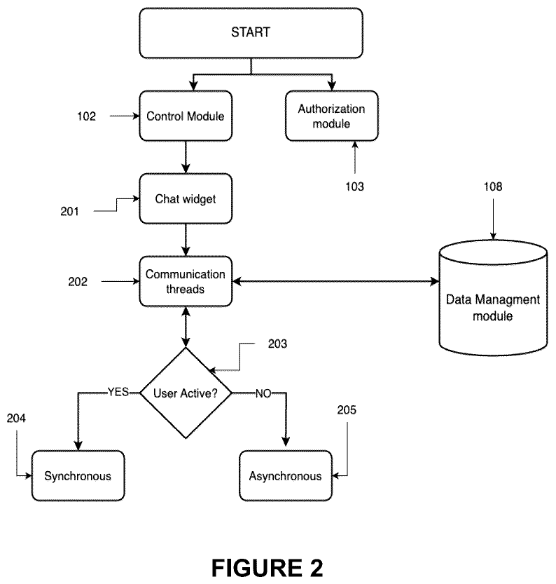

FIG. 3 depicts a flowchart with the communication between the control module, authorization module and database wherein the validation of the list of agents with the access to the chat communication is being disclosed.

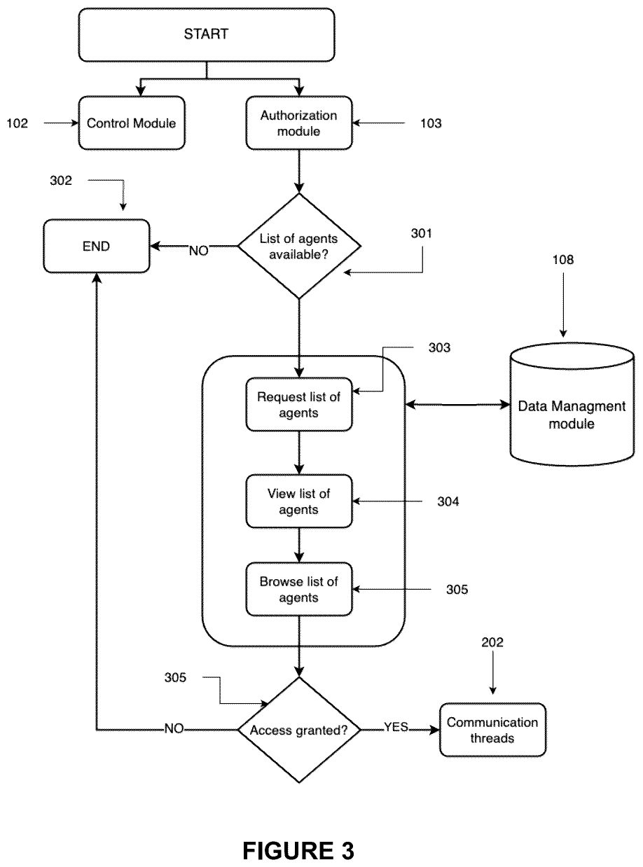

FIG. 4 depicts a flowchart with the communication between the control module, authorization module and database wherein API infrastructure is being disclosed.

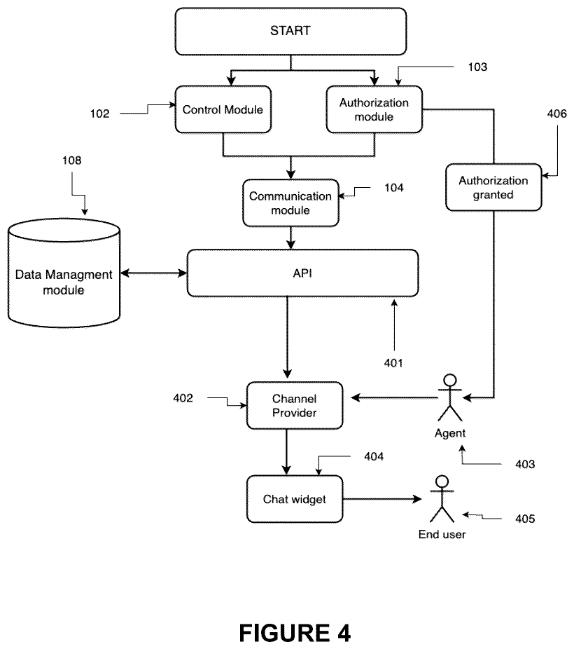

FIG. 5 depicts a view with the message module and input to enter private comment by the at least one agent.

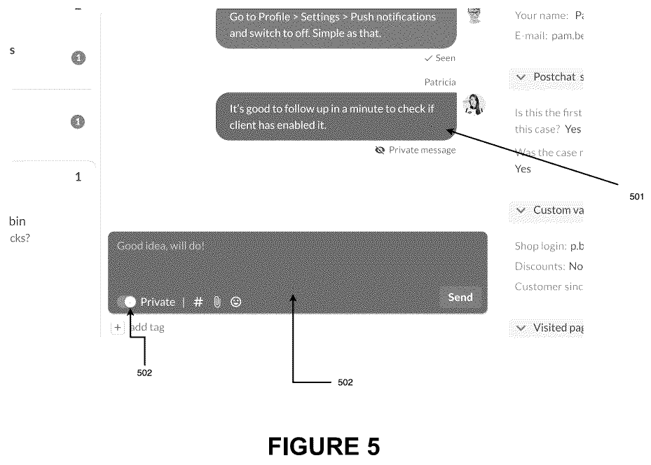

FIG. 6 depicts the functionality of chat takeover within the communication module.

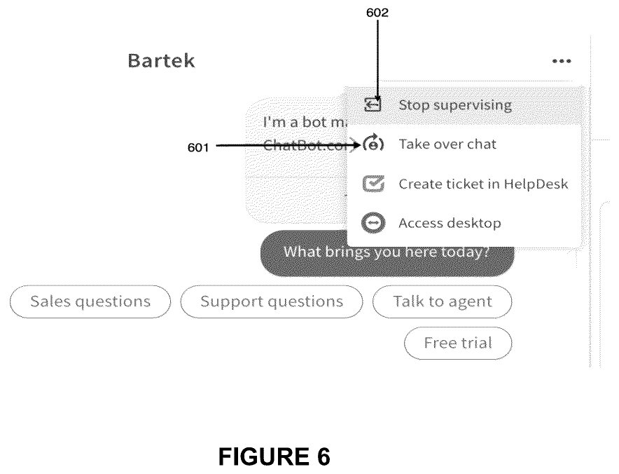

FIG. 7 depicts the functionality of the chat supervisory module on the list of all chats depicted for the agent who was positively validated by the authorization module.

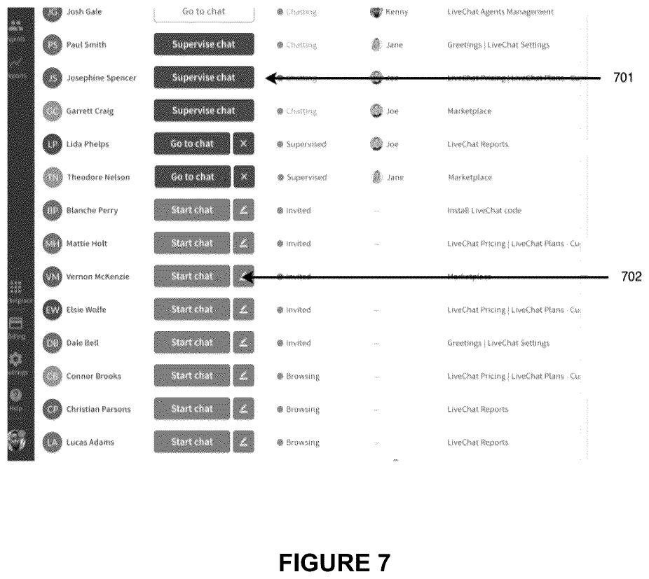

### DETAILED DESCRIPTION OF THE INVENTION

The invention introduces a comprehensive system and method designed to enhance chat interactions within digital communication. This innovation addresses the complexities associated with managing and optimizing chat sessions, focusing on facilitating efficient agent supervision, discreet guidance, and seamless collaboration within the domain of chat-based customer support, assistance, or sales interactions.

The first embodiment of the invention focuses on the seamless integration of a supervisory mechanism into digital communication platforms. This mechanism is responsible for the ability of at least one agent to browse, view and supervise content (701) exchanged in the chat session between the at least one agent and the end user (702). Whereas by the end user one understands the user entering into a chat session with the agent by the use of instant communication channel or other asynchronous communication channel that further leads to the communication via email.

The embodiment of the invention establishes a dedicated environment within the platform, enabling authorized agents to actively oversee and influence ongoing chat sessions in real-time. This integration ensures a unified and efficient workflow for supervisory tasks.

The system of the disclosed invention integrates a control module (102) responsible for overseeing ongoing chat sessions in real-time. This module facilitates the active monitoring and management of chat interactions within digital communication platforms. In conjunction with the control module, the system incorporates an authorization module. This module operates with the authorization module (103) that grants specific privileges to authorized agents, enabling them to engage in active supervision. By active supervision it is understood that the agent can se the communication module (103) to see chat messages exchanged between participants, view the consolidated view of all conversations he is authorized to access (105), suggest or give hints to the agent involved in the chat thread in the way not visible to the end user (106) via input configured on the agent's processor (107). Authorized agents can participate in chat sessions within the scope of their designated roles. A critical component of the system is the consolidated view module (105). This module is configured to provide authorized agents with a comprehensive view of ongoing chat interactions within a predefined account. Through this module, agents gain the ability to access and navigate chat sessions, ensuring efficient oversight (701) and streamlined monitoring. Wherein the oversight means ability to tart supervision of the chat communication (701), overtake the chat (601) where the agent can exclude previously participating agents and engage in the communication instead of them, and stop supervision whenever it is needed (602). Furthermore, the listing of agents with the access to a particular set of chat threads enable to request a list of agents from the database (303), view list of agents based on data saved in the database (304), browse the list of agents (305) and then grant access based on the previously defined elements (305).

The system's communication module is equipped with whisper functionality (106). This functionality serves as a discrete communication channel available exclusively to authorized agents engaged in chat sessions. It facilitates the transmission of guidance, instructions, and insights while preserving agent's communication with the supervisor invisible to the end-user. With the data input (501) the at least one agent can include a comment or feedback and publish it in the form visible only to other agents (501) who were positively validated by the authorization module (406).

Furthermore, the embodiment of the whisper functionality (106) is adaptable to both real-time (204) and asynchronous communication (205) scenarios. In the case of real-time communication (204) the system and method steps enable commenting and sharing feedback hidden from the end user directly in the chat widget (201) accessed by both the agent (403) and the end user (405). In the case of asynchronous communication (205), for example, via email the embodiment of the invention enables to view the comments and feedback in the form of private messages between agents exchanged in the ticketing system wherein the email address used for communication is being connected (501).

The data management module (108) is further configured to store and organize chat session data. It facilitates subsequent operations, including analysis, evaluation, and optimization of supervisory activities. By efficiently managing chat session data, it contributes to the overall effectiveness and efficiency of the supervisory mechanism. In parallel, the system features a data input component thoughtfully arranged on the processor. This arrangement enables the input of text content (107), a fundamental aspect of chat-based communication that is further displayed in the form of comments or private messages (501). Through this input arrangement, agents can engage in interactions, contributing to the overall functionality and utility of the system. Notably, the data management module seamlessly integrates with a cloud-based data storage solution and with a plurality of chat providers (402) via API (401) that further operates between the data management module (108), servers, chat providers (402) and chat widget directly facing the end user (404). This configuration ensures the secure and accessible storage of chat session data. Utilizing cloud storage offers scalability and accessibility advantages, aligning the system with modern data management practices.

Furthermore, the data management module includes the server infrastructure that is utilized as the central hub for orchestrating interactions with the underlying infrastructure. It facilitates data exchange, ensuring efficient data retrieval and storage, real-time updates on ongoing chat interactions, and seamless integration with external services and components through Application Programming Interfaces (401). The server's communication with the infrastructure involves retrieving and storing vital data, such as chat session details and historical records. It continuously receives real-time updates on chat statuses and messages, enabling authorized agents to monitor and intervene promptly. APIs play a pivotal role in enhancing system functionality by enabling integration with external chat providers and cloud storage solutions. This integration ensures that chat sessions conducted on external platforms can be efficiently supervised within the system. APIs also support data analytics, reporting, user authentication, and authorization processes, enhancing the system's overall capabilities and security.

To facilitate the ability of the agent to share feedback and leave comments, the embodiment of the invention enables authorized agents (305) with the capability to perform real-time oversight of active chat sessions (202). Authorized agents gain access to a centralized interface providing a comprehensive view of ongoing chat interactions within a designated account. Through this interface, agents acquire valuable insights into the status, progress, and content of each chat session, facilitating informed decision-making and timely interventions. If the agent is not authorized his ability to supervise chats expires (302).

To facilitate the ability of authorized agents to share feedback and leave comments, the embodiment of the invention employs an authorization system based on predefined access roles (305). At the apex of this hierarchy is the account owner, endowed with the highest level of access allowance, including oversight of all chat sessions within a particular license. Below the owner are administrators, positioned lower in the structure, each entrusted with the responsibility of overseeing a group of agents. Administrators possess the authority to configure permissions within their designated groups, enabling agents to oversee each other's conversations when specific permissions are implemented. This hierarchical system of permissions is structured within the database, where the assignment of an owner represents the highest level, with all chats from a particular license grouped under this privileged account. Subsequently, administrators and agents are nested beneath, reflecting their respective roles within the system's authorization framework.

An example of such a database structure might resemble a hierarchical tree, with the owner at the root, connected to various administrators, and further branching into agent nodes. Each node within this structure represents a specific access level, with the owner node having complete access to all chat sessions, administrators overseeing their designated groups, and agents focusing on handling individual chat interactions. This hierarchical arrangement within the database ensures a well-organized and efficient authorization system, allowing for fine-grained control over access rights and permissions throughout the system.

The whisper functionality constitutes an integral component of the system's user interface, serving as a discreet communication tool for authorized agents. Specifically, a whisper is an inconspicuous notation, taking the form of a comment, deliberately designed to maintain absolute confidentiality, shielded from external stakeholders, including end users. This multifaceted feature accommodates an array of content formats, encompassing alphanumerical text, numerical data, multimedia assets such as video or imagery, voice recordings, and various attachments. Beyond its role as a content presentation mechanism, the whisper function serves as a data input interface, enabling agents to contribute essential insights and guidance seamlessly. Notably, all content generated through this feature undergoes meticulous archival within the system's database. This archival follows a hierarchical structure, initially allocated to the pertinent license, subsequently to the account owner, and incorporates comprehensive metadata encompassing authorship details, tag references, and the content itself.

In communication sessions requiring immediate intervention, the invention facilitates the seamless transition of authorized agents into ongoing chat sessions. This capability is particularly valuable when automated responses prove inadequate or when an agent's response time is delayed. The transition process is executed smoothly and efficiently, allowing agents to step in and address customer inquiries or issues effectively. This feature ensures that customers receive timely assistance and resolutions, ultimately enhancing overall customer satisfaction.

The embodiment of the invention enables agents the flexibility to exit supervisory roles when their presence is no longer required (602). This flexibility extends to both the chat list and the chat interface, permitting agents to adapt swiftly to changing needs and priorities. The exit process ensures that supervising agents can transition between roles with ease, optimizing their availability for other critical tasks or chat sessions.

The embodiment of the invention manages the authorization and access control framework through a series of technical processes. It systematically maintains a registry of agents and their corresponding assignments to specific authorization sets, allowing for granular control over access privileges. This list of agents, along with their authorization set assignments, is readily accessible for administrative oversight, providing a view of the system's user landscape. Owners are assigned with the ability to supervise regardless of the owner of the chat session or agents included thereto. Administrators can navigate this list of agents, facilitating efficient monitoring and management. Moreover, the system offers on-demand verification of authorization set assignments, affording administrators the capability to confirm and adjust access rights promptly. This dynamic adjustment extends to modifying assignments within authorization sets, allowing administrators to fine-tune access permissions in response to evolving requirements. Ultimately, this structured approach grants administrators the ability to confer access to distinct chat session scopes, each aligned with the authorization set's defined parameters, thereby governing precisely which chat sessions each agent can access. The term “authorization set” delineates the boundaries of chat session accessibility for individual agents, ensuring a access control mechanism within the system.

The next embodiment of the invention refers to the ability of tagging within the system. The system incorporates a data tagging framework for effective data management and organization. This mechanism associates metadata with individual data records, enhancing their context and facilitating categorization. Additionally, the system employs a data categorization system that classifies data records into predefined categories based on inherent attributes. A dedicated data labeling module allows for annotation of data records with descriptive labels. The data organization component systematically arranges data records in hierarchical or relational structures, optimizing data accessibility. Furthermore, a specialized data extraction tool is utilized to extract specific data elements from records, enabling focused analysis and utilization of information. These components collectively enhance the system's data management capabilities, ensuring organized, accessible, and actionable data.

The feedback collected in the form of comments or private messages, as outlined in the preceding embodiments and detailed in the provided claim, serves as a valuable resource for refining AI models. This abundant source of user-generated content is utilized to improve the AI's understanding of intricate language patterns, user preferences, and contextual complexities. The metadata associated with individual data records, facilitated by the data tagging mechanism, provides essential context to these feedback entries. The data categorization system further streamlines the process by categorizing feedback into predefined categories, aiding the AI in recognizing recurring themes and topics. Additionally, the data labeling module's annotations contribute to enhancing the AI's comprehension of the content's subtleties.

The hierarchical or relational structures established by the data organization component enable the AI to identify relationships between various feedback elements, fostering a more comprehensive understanding. Lastly, the data extraction tool plays a vital role in efficiently extracting specific insights and patterns from the feedback dataset. This combination of mechanisms, facilitated by efficient API utilization, ensures that feedback-derived data is effectively leveraged to train AI models, ultimately enhancing the system's responsiveness and adaptability to user needs.

1. A system for agent to end user supervisory mechanism, the system comprising:
a control module configured to oversee ongoing chat sessions in real-time;
an authorization module configured to enable authorized agents to conduct active supervision;
a consolidated view module configured to enable agents to view and browse ongoing chat interactions within a defined account;
a communication module configured to enable a whisper functionality to facilitate communication between authorized agents involved in chat sessions,
a data management module configured to store and organize chat session data, facilitate subsequent analysis, evaluation, and optimization of supervisory activities;
a data input arranged on the processor and configured to enable the text content; and
wherein whisper functionality is configured to facilitate transmission of guidance, instructions, and insights visible only for the authorized agents;
wherein whisper functionality is further configured to be available for both real time and asynchronous communication; and
wherein the data management module is arranged in at least one of data storage and cloud storage.

2. The system according to claim 1, wherein the control module is further configured to:
store a list of communication threads available to the whisper functionality; and
wherein the communication threads comprise both synchronous and asynchronous messages enchanted between at least two users; and
wherein the communication threads are configured to be exchanged between at least one user and a chatbot.

3. The system according to claim 1, wherein the authorization module is further configured to:
store a list of agents and assignment to an authorization set;
view the list of agents and assignment to the authorization set;
browse the list of agents;
verify an assignment to the authorization set on demand;
adjust the assignment to authorization set;
grant access to the scope of chat sessions based on the assignment to an authorization set; and
wherein authorization set comprises a scope of chat sessions that the at least one agent can access.

4. The system according to claim 1, wherein the consolidated view module is configured to display all available chat sessions that the at least one agent can access and to adjust the list of the available chat sessions based on the communication with the authorization module.

5. The system according to claim 1, wherein the communication module further comprises:
an API configured to communicate with the data management module over the network; and
wherein the API is configured to communicate with the chat provider; and
wherein the chat provider comprises an external service provider configured to deliver a communication channel configured to enable the chat sessions.

6. The system according to claim 1, wherein the data management module further comprises:
a processor configured to execute data management operations;
a memory storage for storing data records;
input interfaces configured to transmit data records;
output interfaces configured to receive and transmit data records;
a data management algorithm configured to be stored in the memory storage and to operate on the processor; and
wherein the data records comprise chat sessions, list of agents and assignment to an authorization set.

7. The system according to claim 1, wherein the whisper functionality is further configured to:
enable commenting on a chat session of at least one agent;
enable insertion of feedback on a message from the chat session of at least one agent;
enable insertion feedback on a group of messages from the chat session of at least one agent; and
enable tagging at least one agent in a comment or feedback.

8. The system according to claim 1, wherein the data input is further configured to enable alphabetic and numeric signs, tags and file attachments.

9. The system according to claim 7, wherein the whisper functionality is further configured to enable structured form of inserting data supporting training of language models.

10. The system according to claim 8, wherein the tags are further configured to:
display a list of agents;
select at least one agent from the list of agents;
notify the at least one agent selected from the list of agents about a tag; and
wherein the at least one agent is enabled to receive notification about the tag every time the comment with the tag is saved.

11. The system according to claim 9, wherein the structured form of inserting data supporting training of language models further comprises:
a data tagging mechanism configured to associate metadata with individual data records;
a data categorization system configured to classify data records into predefined categories;
a data labeling module configured to annotate data records with labels indicative of their content;
a data organization component configured to arrange data records in hierarchical or relational structures; and
a data extraction tool configured to extract specific data elements from data records.

12. A method for agent to end user supervisory mechanism, the method comprising the steps of:
overseeing of ongoing chat sessions in real-time with a control module;
authorizing agents with an authorization module;
permitting and enabling agents or authorized agents to conduct active supervision;
enabling agents to view and browse ongoing chat interactions within a defined account with a consolidated view module;
facilitating communication between authorized agents involved in a chat sessions with a communication module;
storing and organizing chat session data with a data management module;
facilitating analysis of chat session data with a data management module;
optimizing supervisory activities of chat session data with a data management module;
enabling comments with text with use of a data input arranged on the processor;
tagging the at least one agent in the comments;
wherein whisper functionality is enabled to facilitate transmission of guidance, instructions, and insights visible only to the authorized agents;
wherein the whisper functionality is configured to be available for both real time and asynchronous communication; and
wherein the data management module is arranged on at least one of data storage and cloud storage.

13. The method according to claim 12, further comprising the steps of:
storing a list of communication threads available to the whisper functionality; and
wherein communication threads comprises both synchronous and asynchronous messages enchanted between at least two users.

14. The method according to claim 12, further comprising the steps of:
storing a list of agents and assignment to an authorization set;
viewing the list of agents and assignment to the authorization set;
browsing the list of agents;
verifying an assignment to the authorization set on demand;
adjusting the assignment to authorization set;
granting access to the scope of chat sessions based on the assignment to an authorization set; and
wherein authorization set comprises a scope of chat sessions that the at least one agent can access.

15. The method according to claim 12, further comprising the steps of:
enabling communication between a management module over the network with the use of API; and
wherein the API is further configured to communicate with the chat provider; and
wherein the chat provider comprises an external service provider configured to deliver a communication channel configured to enable the chat sessions.

16. The method according to claim 12, further comprising the steps of:
executing data management operations with a processor;
storing data records on a memory storage;
transmitting data records with an input interfaces;
transmitting data records with an output interfaces;
configurating and implementing a data management algorithm to be stored in the memory storage and operate on the processor; and
wherein the data records comprise chat sessions, list of agents and assignment to an authorization set.

17. The method according to claim 12, further comprising the steps of:
enabling commenting on a chat session of at least one agent;
enabling insertion of feedback on a message from the chat session of at least one agent;
enabling insertion of feedback on a group of messages from the chat session of at least one agent; and
enabling tagging of at least one agent in a comment or feedback.

18. The method according to claim 12, further comprising the steps of:
displaying a list of agents;
selecting at least one agent from the list of agents;
notifying the at least one agent selected from the list of agents about a tag; and
wherein the at least one agent receives notification about the tag every time the comment with tag is saved.

19. The method according to claim 18 further comprising the steps of:
associating metadata with individual data records with a data tagging mechanism;
classifying data records into predefined categories with a data categorization system;
annotating data records with labels indicative of their content with a data labeling module;
arranging data records in hierarchical or relational structures with a data organization component configured to; and
extracting specific data elements from data records with a data extraction tool.
